(19) United States
(12) Patent Application Publication
(10) Pub. No.: US 2007/0118579 A1
(43) Pub. Date: May 24, 2007

(54) Dynamic consistency between multiple versions of objects managed by a garbage collector using transactional memory support

(76) Inventor: Richard L. Hudson, Florence, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/284,510

(22) Filed: Nov. 21, 2005

(51) Int. Cl. G06F 17/30

(52) U.S. Cl. 707/206

(57) ABSTRACT

Embodiments of the invention relate to a transactional memory engine to implement a transactional memory instruction set including transactional memory commands included in a processor. The transactional memory engine performs a copy command utilizing transactional memory commands to copy a value from an old object in an old memory space to a new object in a new memory space during garbage collection activities performed by a garbage collector and enables a copy-write-barrier utilizing transactional memory commands to ensure dynamic consistency between objects managed by the garbage collector during application activities.

### BACKGROUND

1. Field

Embodiments of the invention relate to providing dynamic consistency between multiple versions of objects managed by a garbage collector using transactional memory support.

2. Description of Related Art

Due to great demand for software programs and the popularization of the World Wide Web, software developers need to create software that runs on a variety of different computers. For example, while millions of people around the globe are surfing the Internet and browsing web pages with their computers, not all of these computers are the same. Therefore, software developers have found it desirable to design computer programs that can support multiple host architectures. Programmers have accomplished this by using object-oriented languages, such as Java, that allow for application development in the context of heterogeneous, network-wide, distributed environments. Object-oriented languages, such as Java, may include automatic memory storage management to take over the burden of memory management from the programmer. One way this is accomplished is by utilizing a garbage collector.

Particularly, when a program runs low on heap space, a garbage collector determines the set of objects that the program may still access. Objects in this set are known as live objects. The space used by objects that no longer need to be accessed (“dead objects”) may be freed by the garbage collector for future use. An object is defined as a collection of contiguous memory locations, lying in a single region that can be addressed and accessed via references. A reference, also called a pointer, is the address of an object. Objects do not overlap and may be relocated independently of one another by the garbage collector. In some cases, an object may correspond to a Java object. An object may contain slots, non-slot data, or both. A slot is a memory location that may contain a reference (pointer) to an object. A slot may also refer to no object, i.e., contain the null pointer. Memory locations can be categorized into slots and non-slot data correctly and unambiguously.

There are many known algorithms for performing garbage collection. Most algorithms start with a set of roots that enumerate all of the objects in the heap that are directly reachable. A root is a slot whose referent object (if any), is considered reachable. All objects transitively reachable from roots are also considered reachable. The remaining objects in the heap are unreachable and can be reclaimed. The most common type of garbage collection is precise garbage collection. In precise garbage collection, the root set must unambiguously contain all reference values, or else memory errors will result. This is because precise garbage collection typically compacts the memory space by moving all the objects it finds to another memory region. The values in the root set must contain reference values since the garbage collector copies and moves the objects pointed to by references, and then updates the references correspondingly. If a value is mistakenly considered a reference value when it is not, a wrong piece of data will be moved, and/or a non-reference mistakenly modified, and program errors may occur.

The garbage collector typically moves objects around the heap for many reasons, for example, to eliminate fragmentation, to improve cache performance, and to reduce application thread latency. One particular algorithm disclosed in U.S. Pat. No. 6,671,707 describes a concurrent copying garbage collection algorithm that provides for minimal thread blocking times and achieves dynamic consistency between objects in old memory space and objects in new memory space (hereinafter referred to as the “dynamically consistent garbage collection algorithm”). In the dynamically consistent garbage collection algorithm (DCGA), threads are allowed to progress during garbage collection and threads are flipped one at a time. DCGA was designed to provide a high level of concurrency between the garbage collector and an application thread while still providing the benefit of moving objects.

In DCGA, regions or objects are divided into collected and uncollected sets. Objects in collected areas are moved by creating space for new versions of the object, copying the content of the old version of the object, re-pointing old version references to the new version, and finally releasing the memory used for the old object so it can be reused for other objects. During the phase between when the new version of an object is allocated and all references to the old version are re-pointed to the new version, the application thread may have pointers to both versions and be able to observe both versions. If one application thread updates one version of the object without updating the other, then an application thread could view an out of date and inconsistent object. The DCGA of U.S. Pat. No. 6,671,707 sets forth an approach to provide dynamic consistency in order to ensure that an application thread only sees an up-to-date, valid, and consistent version of an object even though multiple versions of the object may simultaneously exist.

However, the dynamically consistent garbage collector algorithm (DCGA) relies on a high level memory ordering scheme and a very complicated algorithm in order to maintain this dynamic consistency.

### BRIEF DESCRIPTION OF THE DRAWINGS

FIG. 1 is a block diagram of the elements of a device equipped to interpret and compile class files from an object oriented language, such as Java, illustrating an environment in which embodiments of the invention may be utilized.

FIG. 2 is a partial block diagram of an example of a computer system hardware configuration, in which embodiments of the invention may be practiced.

FIG. 3 is an example of pseudo-code that may be utilized to implement a copy phase, according to one embodiment of the invention.

FIG. 4 is an example of pseudo-code that may be utilized to implement a flip phase, according to one embodiment of the invention.

FIG. 5 is an example of pseudo-code that may be utilized to extend uni-processor read barriers to multi-processor environments utilizing transactional memory commands, according to one embodiment of the invention.

### DESCRIPTION

In the following description, the various embodiments of the invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the embodiments of the invention, it will be apparent to one skilled in the art that these specific details are not required in order to practice the embodiments of the invention. In other instances details such as, well-known methods, types of data, protocols, procedures, components, electrical structures and circuits, are not described in detail, or are shown in block diagram form, in order not to obscure the invention. Furthermore, embodiments of the invention will be described in particular embodiments but may be implemented in hardware, software, firmware, middleware, or a combination thereof.

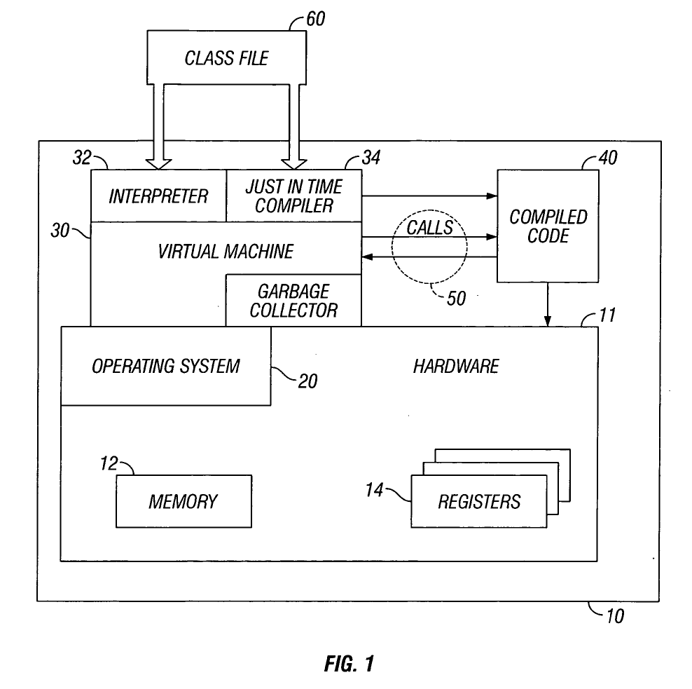

Turning to FIG. 1, FIG. 1 is a block diagram of the elements of a device 10 equipped to interpret and compile class files from an object oriented language, such as Java, illustrating an environment in which embodiments of the invention may be utilized. The device 10 includes computer hardware 11 controlled by an operating system 20. The computer hardware further comprises computer memory 12 and machine registers 14. The device 10 also includes a virtual machine (VM) implementation 30 for executing code contained in class files 60, such as Java. The virtual machine (VM) implementation 30 includes a garbage collector 36.

For example, in a network environment, a user would first access the computer server through a network and download the desired class files 60 into a device 10. After each class file has been verified, the interpreter 32 may begin interpreting the class file such that the code is executed.

Alternatively, a just-in-time compiler 34 may compile the class file and generate compiled code 40 in the form of native processor code. The compiled code 40 may be directly executed by computer hardware 10. In order to maintain the state of the virtual machine 30 and to make system calls, compiled code 40 may make calls 50 into virtual machine 30. Likewise VM 30 calls 50 compiled code 40 to cause it to execute on the computer hardware 10.

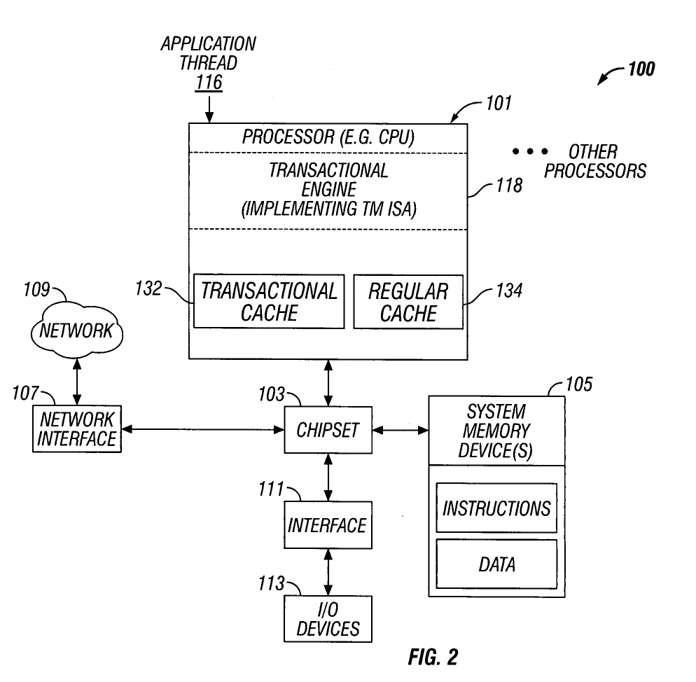

Turning now to FIG. 2, FIG. 2 shows a partial block diagram of an example of a computer system hardware configuration 100, in which embodiments of the invention may be practiced. The system configuration 100 includes at least one processor 101 such as a central processing unit (CPU), a chipset 103, system memory devices 105, one or more interfaces 111 to interface with one or more input/output (I/O) devices 113, and a network interface 107.

The chipset 103 may include a memory control hub (MCH) and/or an I/O control hub (ICH). The chipset 103 may be one or more integrated circuit chips that act as a hub or core for data transfer between the processor 101 and other components of the computer system 100. Further, the computer system 100 may include additional components (not shown) such as other processors (e.g., in a multi-processor system), a co-processor, as well as other components, etc.—this being only a very basic example of a computer system.

For the purposes of the present description, the term “processor” or “CPU” refers to any machine that is capable of executing a sequence of instructions and should be taken to include, but not be limited to, general purpose microprocessors, special purpose microprocessors, application specific integrated circuits (ASICs), multi-media controllers, digital signal processors, and micro-controllers, etc. In one embodiment, the CPU 101 is a general-purpose high-speed microprocessor that is capable of executing an Intel Architecture instruction set. For example, the CPU 101 can be one of the INTEL® PENTIUM a classes of processors, such as INTEL® Architecture 32-bit (IA-32) processor (e.g., PENTIUM® 4M).

The CPU 101, the chipset 103, and the other components access system memory devices 105 via chipset 103. The chipset 103, for example, with the use of a memory control hub, may service memory transactions that target system memory devices 105.

System memory devices 105 may include any memory device adapted to store digital information, such as static random access memory (SRAM), dynamic random access memory (DRAM), synchronous dynamic random access memory (SDRAM), and/or double data rate (DDR) SDRAM or DRAM, etc. Thus, in one embodiment, system memory devices 105 include volatile memory. Further, system memory devices can also include non-volatile memory such as read-only memory (ROM).

Moreover, system memory devices 105 may further include other storage devices such as hard disk drives, floppy disk drives, optical disk drives, etc., and appropriate interfaces.

Further, computer system 100 may include suitable interfaces 111 to interface with 1/O devices 113 such as disk drives, monitors, keypads, a modem, a printer, or any other type of suitable I/O devices.

Computer system 100 may also include a network interface 107 to interface the computer system 100 with a network 109 such as a local area network (LAN), a wide area network (WAN), the Internet, etc.

The basic computer system configuration 100 of FIG. 1 is an example of one type of computer system that may be utilized to implement embodiments of the invention. It should be appreciated by those skilled in the art that the exemplary FIG. 1 computer system configuration 100 is only one example of a basic computer system and that many other types and variations are possible. Further, those skilled in the art will recognize that the exemplary environment illustrated in FIG. 1 is not intended to limit the embodiments of the invention. Moreover, it should be appreciated that in addition to, or in lieu of, the single computer system configuration 100, clusters or other groups of computers (similar to or different from computer system configuration 100) may be utilized in practicing embodiments of the invention.

As shown in FIG. 2, processor 101 may include a transactional memory (TM) engine 118 that may be utilized to implement embodiments of the invention related to providing dynamic consistency between multiple versions of objects managed by a garbage collector utilizing transactional memory for application threads 116. Particularly, transactional engine 118 includes standard transactional memory (TM) functionality including a TM instruction set architecture (ISA) implemented by transactional engine 118, as will be discussed in more detail later, to implement embodiments of the invention. Also, processor 101 includes a transactional cache 132 to implement TM functionality and a regular memory cache 134. The transactional cache 132 may be combined with the regular cache 134.

As will be discussed in more detail later, the TM ISA enables the TM engine to provide transactional memory support for providing dynamic consistency between multiple versions of objects managed by a garbage collector to application threads 116. Transactional cache 132 operates in conjunction with transactional engine 118 to enable transactional memory support in a high performance manner.

Further, a compiler and run-time system may include instructions and data used in implementing dynamic consistency between multiple versions of objects managed by a garbage collector utilizing transactional memory support in conjunction with transactional engine 118 of processor 101. For example, the instructions and data may reside in system memory devices 105 or other data storage devices. In an alternative embodiment, the compiler and run-time system can be downloaded through a network. Application code may be stored in system memory devices 105 or a I/O data storage device 113. Application code can also be downloaded through the network.

It should be appreciated that although the above example describes a distribution of a class file, such as a Java class file, via a network, Java programs may be distributed by way of other computer readable media. For instance, a computer program may be distributed to a computer readable medium such as a floppy disk, a CD ROM, a carry away, or even transmission over the Internet.

Further, while embodiments of the invention and several functional components have, and will be described, in particular embodiments, these aspects and functionalities can be implemented hardware, software, firmware, middleware, or a combination thereof.

Transactional engine 118 may enable hardware-based transaction memory (TM), sometimes referred to as transactional execution. TM execution allows applications, programs, modules, etc., and more particularly application threads, to access memory in an atomic, consistent, and isolated manner. Transactional memory makes it easy for programmers to write parallel programs and the use of transactional memory execution allows for different application threads to communicate through and coordinate access to shared data. This allows the threads to operate simultaneously thereby gaining extremely high processing efficiency.

Looking more particularly at transactional memory (TM) execution as may be implemented by transactional engine 118 and transactional cache 132, transactional execution typically involves performing transactional memory (TM) operations that satisfy properties referred to as ACID properties. The first ACID property is atomicity. Atomicity requires that a transaction be performed in an ALL/OR nothing manner. A memory transaction may be aborted either because an application thread aborts or due to an error. Atomicity requires that either all of the operation of the transaction be performed, or none of it be performed. The second ACID property is consistency. Consistency requires that if the memory is in a consistent state before the transaction is performed, the memory should be left at a consistent state. The third ACID property is isolation. The isolation property states that all transactions to be performed have to appear to be done in some sort of serial order.

The last and fourth property required of the ACID properties is durability. Durability requires that a transaction be able to survive a machine crash. That is, a transaction has to be written to a stable storage device (e.g. a disk) before it can be committed. However, it should be noted that not all implementations of TM, require a transaction to satisfy all of the four above-described ACID properties. For example, in many implementations durability is not a requirement.

Beyond being compliant with all or some of the above-described ACID properties, transactional memory (TM) execution may also be required to support concurrent execution, deadlock freedom, and non-blocking properties. Typically, concurrent execution of non-conflicting transactions is supported by TM execution. Deadlock freedom may be implemented in TM execution by, once detecting a deadlock, recovering from the deadlock by simply aborting some of the transactions. The non-blocking or obstruction-freedom property is required to prevent an application thread from hindering the progress of other threads in transactional memory systems.

Transactional engine 118 utilizing transactional cache 132 may provide TM support, including some or all of the previously-described functions in order to provide dynamic consistency between multiple versions of objects managed by a garbage collector, as will be discussed.

Moreover, transactional engine 118 implements a simple TM ISA that includes very few operations to enable TM functionality. Particularly, TM engine 118 only includes a few simple instructions that delineate the start of a transaction and provides a location to go to if the transaction aborts (e.g. often termed an “abort handler”). Transactional engine 118 also provides an instruction to indicate when a transaction should commit. Thus, transactional engine 118 may operate with as few as four very simple instructions: Begin, End, Commit, and Abort.

A transaction consists of the instructions between the transaction begin and the transaction commit instruction. When a transaction commits, the results of the instructions appear atomic to the other application threads. TM functionality ensures that a minimum number of independent locations can be involved in a transaction without concern for overflow. This is called a non-overflow guarantee for a transactional memory system. If a transaction does not overflow and no other application thread accesses the memory location within a transaction, then the transaction will commit. The transaction will only abort if there is a contention for the memory location accessed by the transaction.

The following definitions may be useful in explaining the following methodology. A memory region may contain slots as well as non-slot data. A slot is a memory location that may contain a pointer. For one embodiment of the present invention, three distinct regions are defined:
U (Uncollected)—A region of the heap (i.e., potentially shared among all threads) whose objects are not subject to reclamation in a particular cycle of the collector. For convenience, U also includes all non-thread-specific slots not contained in objects, such as global variables of the virtual machine itself. U also includes slots managed by interfaces such as the Java Native Interface (JNI) on behalf of code external to the virtual machine.
C (Collected)—A region of the heap (potentially shared among all threads) whose objects are subject to reclamation in a particular cycle of the collector. C consists only of objects and all slots are contained within an object. C is further divided into:
   O (Old space)—Copies of objects as they existed when the collector cycle started.
   N (New space)—New copies of objects surviving the collection.
S (Stack)—Each thread has a separate stack, private to that thread. S regions contain slots, but no objects, i.e., there may be no pointers from heap objects into stacks. For convenience, other thread-local slots are included into S, notably slots corresponding to those machine registers containing references.

Embodiments of the invention relate to a transactional memory engine 118 to implement a transactional memory instruction set including transactional memory commands included in the processor 101. As will be described, the transactional memory engine 118 performs a copy command utilizing transactional memory commands to copy a value from an old object in an old memory space to a new object in a new memory space (e.g., in system memory devices 105) during garbage collection activities performed by the garbage collector and enables a copy-write-barrier utilizing transactional memory commands to ensure dynamic consistency between objects managed by the garbage collector during application activities.

As will be described, the transactional memory commands that may be utilized to implement this copying functionality may include begin and commit transactional memory commands. Further, the transactional memory engine 118 may abort the copy command utilizing a transactional memory abort handler if there is a contention for fields of the objects. Also, the transactional memory engine 118 may perform a flip routine utilizing transactional memory commands to flip pointers to change pointers referring to old objects to refer to corresponding new objects such that application threads see consistent values. A flip phase write barrier utilizing transactional memory commands may also be utilized. The transactional memory cache 132 located in the processor 101 may be used to aid in implementing the transactional memory commands in a hardware-accelerated manner.

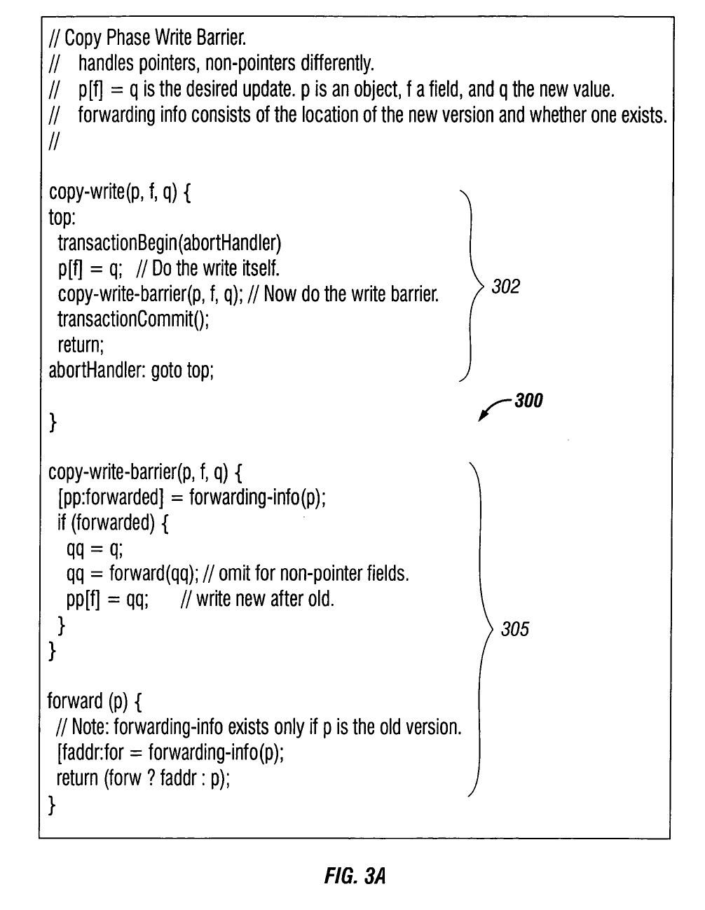

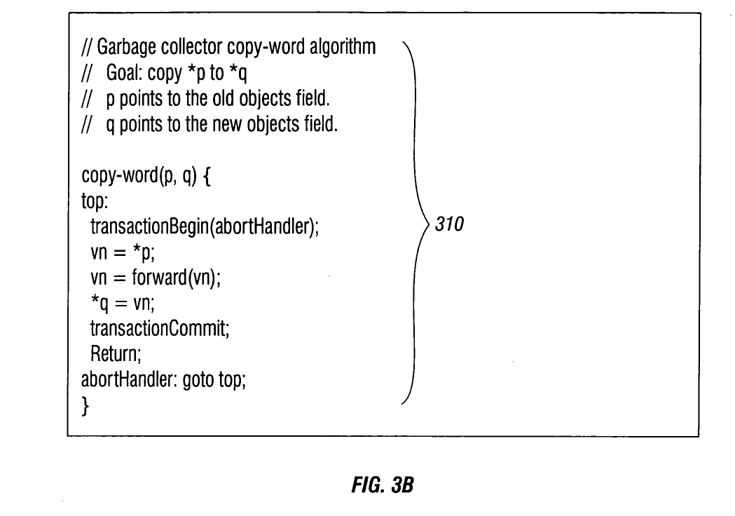

With reference now to FIG. 3, routines used during the copy phase that ensures dynamic consistency between multiple versions of objects managed by a garbage collector utilizing transaction memory (TM) support, will be discussed. FIG. 3 is an example of pseudo-code that may be utilized to implement the copy phase.

FIG. 3 illustrates pseudo-code 300 that may be utilized to perform the copy-write and implement a write barrier that supports dynamic consistency utilizing transactional memory. As can be seen in the pseudo-code of FIG. 3, the copy-write phase (shown in section 302 of pseudo-code 300) utilizes a TM begin transaction to indicate the start of the copy-write transaction and a TM commit transaction to commit the transaction. Further, as inherent in TM transactions, an abort handler is utilized to handler abort operations if the transaction cannot commit. It should be appreciated that FIG. 3 only presents portions of pseudo-code relevant to the copy phase and write barrier of the garbage collector.

Looking particularly at the pseudo-code of FIG. 3, P[F]=Q; wherein P is an object, F is a field, and Q is the desired update. The forwarding information includes the location of a new version of the object P and whether one exists.

As can be seen in pseudo-code section 302, a copy-write command with variables P, F, and Q begins with a TM transaction begin (with an abort handler set) and a command to perform the write P[F]=Q. A copy-write-barrier is then initiated. The copy-write-barrier can be seen in section 305 of the pseudo code 300. The copy-write-barrier determines whether or not the P and Q values are the most recent values. The forwarding of information only occurs if P is an old version. If P is an old version, then newer versions of P is updated with the newer version of Q if one exists.

Looking to the pseudo-code of FIG. 3, and particularly at pseudo-code section 310, pseudo-code is illustrated to perform the copy-word function. This function is used to copy the contents of the old version to the new version. As can be seen in pseudo-code section 310, the garbage collector copy-word algorithm copies *P to *Q; wherein P points to the old object field and Q points to the new object field.

More particularly, a begin TM transaction (with the abort handler set) begins the copy-word transaction. As shown in pseudo-code section 310 VN is first set to the old value of the old object field; VN is then set to the forwarded value if one exists; and finally Q is updated with the new value VN. After this a commit TM transaction is issued and the copy-word transaction is committed.

It should be noted that by using TM execution and TM commands, that if there is any contention for the fields, then the application thread or the collector code will abort and be retried. During this time, with the use of the write-barrier, the application threads can only see the old version of the objects, and all writes to the old version of the objects are reflected to the new version of the objects.

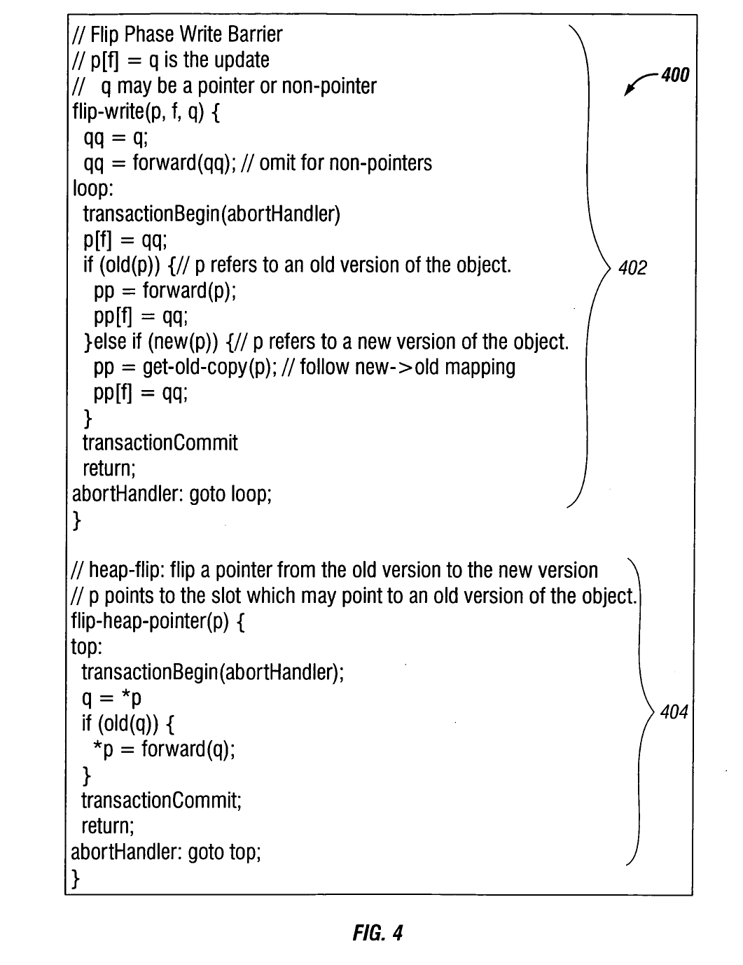

With reference now to FIG. 4, FIG. 4 illustrates pseudo-code that may be utilized to implement the flip phase utilizing TM execution support, according to one embodiment of the invention. As can be seen in pseudo-code 400 of FIG. 4, pseudo-code section 402 implements a flip phase write barrier by first issuing a flip-write command for variables P, and Q and for field F within P. The flip-write command includes the use of a flip phase write barrier. QQ is set to the new version of Q if one exists, otherwise it is set to Q. TM execution support is utilized in which a begin TM transaction is issued (utilizing an abort handler) and if an new version of P exists, both the old and the new version of P's field F is set to QQ and the TM transaction is committed. At this commit both the new and the old version of P will be dynamically consistent.

Next, as seen in pseudo code section 404, the flip routine is performed utilizing TM execution support. During this flip routine, a pointer to the old version is flipped to refer to the new version if one exists. As can be seen, a command to flip the heap pointer P is issued and utilizing TM execution support, a begin TM transaction (with an abort handler set) begins the TM transaction such that a pointer from the old version is flipped to the new version (e.g. *P) and the transaction is committed (TM transaction commit).

Advantageously, TM execution guarantees that if a transaction reads a global variable as the first action within a transaction, and the transaction commits, then it is assured that the state has not changed. Prior garbage collector algorithms required a barrier insuring that all application threads wait until all the application threads acknowledged the global state change.

By utilizing TM execution, the need to bring all the application threads to a garbage collector safe point and acknowledge the state change, is sidestepped. Instead, an application thread can start a transaction, read the flavor of the write barrier, perform the write barrier, and commit the transaction. Even if the flavor of the write barrier changes during the write barrier, then the write barrier will abort and the mutator will retry the write barrier.

While this methodology does not completely eliminate the need for bringing the application threads to a garbage collector safe point in order to enumerate the roots, it does avoid having to bring the application threads to a garbage collector safe point in order to install the next phase of the write barrier. This may be highly valuable in a highly concurrent environment.

In another embodiment of the invention, as illustrated in the pseudo-code of FIG. 7, TM execution support may be used to extend uni-processor read barriers to multi-processor environments. For example, it has been previously shown how to extend a uni-processor to allow concurrent collectors by introducing a read barrier. [Trading Data Space for Reduced Time and Code Space in a Real-Time Garbage Collection on Stock Hardware, Brooks, Rodney A. In Conference Record of the 1984 ACM Symposium on Lisp and Functional Programming (Austin Tex., Aug, 1984), G. L. Steele, Ed, pp 256-262]. This is known in the art as the Brooks barrier. It has further been shown how to adapt the Brooks barrier in order to successfully control the time (latency) space tradeoffs. [Real Time Garbage Collector with Low Overhead and Consistent Utilization, David F. Bacon, Perry Cheng, and V. T. Rajan, Conference Record of the Thirtieth ACM Symposium on Principles of Programming Languages (New Orleans, La., Jan, 2003), pp. 285-298]. This is known in the art as the Bacon adaption.

Unfortunately, both the Brooks read barrier, and the Bacon adaptation thereof, were both done in the context of a uni-processor because the installation of a Brooks read barrier produces a race condition. It should be noted that the Brooks read barrier utilizes an extra slot at the top of each object to hold the pointer to the current version of the object. Typically, this is a simple reference to itself. The Brooks read barrier is valuable in that it is non-conditional and in the common case, does not involve a cache miss, since the cache line is likely to be referenced to retrieve the field of the object.

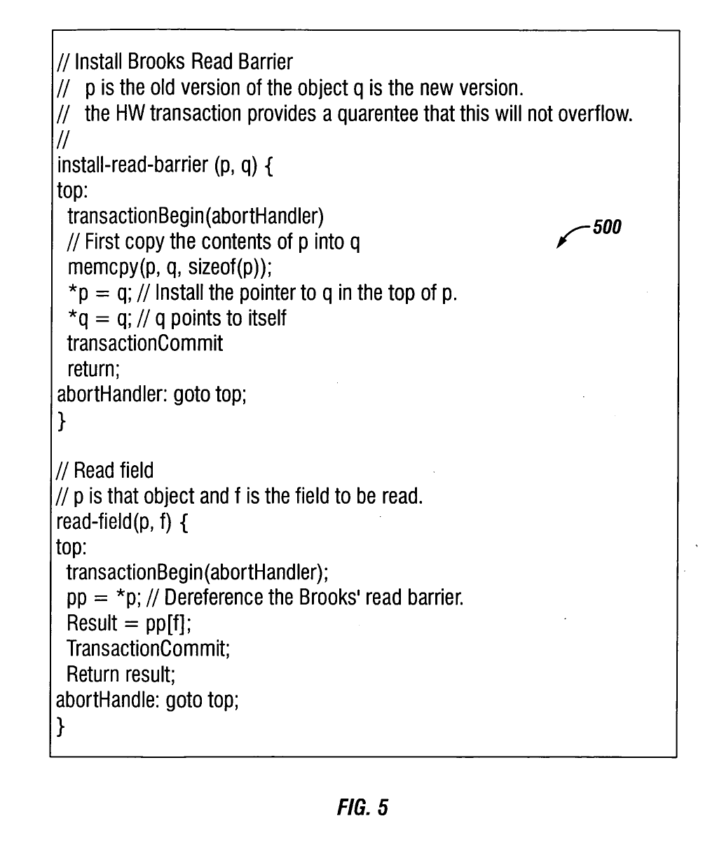

By utilizing the Brooks read barrier in a TM execution environment, as shown in pseudo-code 500 of FIG. 5, the TM execution environment provides a guarantee that the Brooks read barrier can be used in a multi-processor environment.

As shown in pseudo-code 500, the Brooks read barrier with objects P and Q is installed. P refers to the old version of the object and Q refers to the new version. The read barrier utilizing TM execution support, starting with a begin TM transaction (with the abort handler set), copies the contents of P into Q, installs the pointer to Q in the top of P, ensures Q points to itself, and commits the transaction via a commit TM transaction. If the size of the object P is large it may overflow a hardware transactional memory implementation, in which case it must fall back onto software transactional memory approaches.

The read field command is also executed utilizing TM execution support with a begin TM transaction and commit TM transaction. In this way, a Brooks read barrier may be utilized with the TM execution support such that it may be utilized in a multi-processor system.

While embodiments of the present invention and its various functional components have been described in particular embodiments, it should be appreciated the embodiments of the present invention can be implemented in hardware, software, firmware, middleware or a combination thereof and utilized in systems, subsystems, components, or sub-components thereof. When implemented in software or firmware, the elements of the present invention are the instructions/commands/code segments to perform the necessary tasks. The program or code segments can be stored in a machine readable medium (e.g. a processor readable medium or a computer program product), or transmitted by a computer data signal embodied in a carrier wave, or a signal modulated by a carrier, over a transmission medium or communication link.

The machine-readable medium may include any medium that can store or transfer information in a form readable and executable by a machine (e.g. a processor, a computer, etc.). Examples of the machine-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, bar codes, etc. The code segments may be downloaded via networks such as the Internet, Intranet, etc.

Further, while embodiments of the invention have been described with reference to illustrative embodiments, these descriptions are not intended to be construed in a limiting sense. Various modifications of the illustrative embodiments, as well as other embodiments of the invention, which are apparent to persons skilled in the art to which embodiments of the invention pertain, are deemed to lie within the spirit and scope of the invention.

What is claimed is:

1. An apparatus comprising:
a processor; and
a transactional memory engine to implement a transactional memory instruction set including transactional memory commands included in the processor, the transactional memory engine to:
perform a copy command utilizing transactional memory commands to copy a value from an old object in an old memory space to a new object in a new memory space during garbage collection activities performed by a garbage collector; and
enable a copy-write-barrier utilizing transactional memory commands to ensure dynamic consistency between objects managed by the garbage collector during application activities.

2. The apparatus of claim 1, wherein the transactional memory commands include at least one of a begin transactional memory command and a commit transactional memory command.

3. The apparatus of claim 1, wherein the transactional memory engine aborts the copy command utilizing a transactional memory abort handler if there is a contention for fields of the objects.

4. The apparatus of claim 1, wherein the transactional memory engine further performs a flip routine utilizing transactional memory commands to flip pointers to change pointers referring to old objects to refer to corresponding new objects such that application threads see consistent values.

5. The apparatus of claim 4, wherein the flip routine further comprises enabling a flip phase write barrier utilizing transactional memory commands.

6. The apparatus of claim 5, wherein the transactional memory commands include at least one of a begin transactional memory command and a commit transactional memory command.

7. The apparatus of claim 1, further comprising a transactional memory cache located in the processor to aid in implementing transactional memory commands.

8. A method comprising:
performing a copy command utilizing transactional memory commands to copy a value from an old object in an old memory space to a new object in a new memory space during garbage collection activities performed by a garbage collector; and
enabling a copy-write-barrier utilizing transactional memory commands to ensure dynamic consistency between objects managed by the garbage collector during application activities.

9. The method of claim 8, wherein the transactional memory commands include at least one of a begin transactional memory command and a commit transactional memory command.

10. The method of claim 8, further comprising aborting the copy command utilizing a transactional memory abort handler if there is a contention for fields of the objects.

11. The method of claim 8, further comprising, performing a flip routine utilizing transactional memory commands to flip pointers to change pointers referring to old objects to refer to corresponding new objects such that application threads see consistent values.

12. The method of claim 11, wherein the flip routine further comprises enabling a flip phase write barrier utilizing transactional memory commands.

13. The method of claim 12, wherein the transactional memory commands include a begin transactional memory command.

14. The method of claim 13, wherein the transactional memory commands include a commit transactional memory command.

15. A machine-readable medium having stored thereon instructions, which when executed by a machine, cause the machine to perform the following operations comprising:
performing a copy command utilizing transactional memory instructions to copy a value from an old object in an old memory space to a new object in a new memory space during garbage collection activities performed by a garbage collector;
enabling a copy-write-barrier utilizing transactional memory instructions to ensure dynamic consistency between objects managed by the garbage collector during application activities; and
performing a flip routine utilizing transactional memory instructions to flip pointers to change pointers referring to old objects to refer to corresponding new objects such that application threads see consistent values

16. The machine-readable medium of claim 15, wherein the transactional memory instructions include a begin transactional memory instruction.

17. The machine-readable medium of claim 15, wherein the transactional memory instructions include a commit transactional memory instruction.

18. The machine-readable medium of 15, wherein the transactional memory instructions include an abort instruction to abort the copy command utilizing a transactional memory abort handler if there is a contention for fields of the objects.

19. The machine-readable medium of claim 15, wherein the flip routine further comprises enabling flip phase write barrier utilizing transactional memory instructions.

20. The machine-readable medium of claim 19, wherein the transactional memory instructions include at least one of a begin transactional memory instruction and a commit transactional memory instruction.
